(19) United States
(12) Patent Application Publication
(10) Pub. No.: US 2014/0260158 A1
(43) Pub. Date: Sep. 18, 2014

(54) HARVESTER WITH EXTENDABLE REAR AXLE

(71) Applicant: AGCO CORPORATION, Duluth, GA (US)

(72) Inventors: Darren J. Nelson, Hutchinson, KS (US); Steven R. Tippery, Newton, KS (US)

(73) Assignee: AGCO CORPORATION, Duluth, GA (US)

(21) Appl. No.: 13/837,449

(22) Filed: Mar. 15, 2013

Related U.S. Application Data
(60) Provisional application No. 61/779,775, filed on Mar. 13, 2013.

(51) Int. Cl. A01D 41/12

(52) U.S. Cl. CPC A01D 41/12
USPC 56/16.7

(57) ABSTRACT

A combine harvester has a rear axle that can be extended on-the-go to enable its ground wheels to be turned more sharply during steering operations without striking nearby portions of the chassis. Extension may be carried out manually by the driver or automatically in response to a predetermined input, such as the commencement of a turn by the harvester. In one embodiment the rear ground wheels are powered, such as by a single hydraulic or electric motor, while in another embodiment they are non-powered.

### RELATED APPLICATIONS

This application is related to and claims the priority benefit of prior co-pending U.S. Provisional Application No. 61/779,775 filed Mar. 13, 2013, said Provisional Application in its entirety being hereby incorporated by reference into the present specification.

### TECHNICAL FIELD

The present invention relates to the field of crop harvesting machines and, more particularly, to a combine harvester having a rear axle that can be extended “on-the-go” to facilitate steering of the harvester.

### BACKGROUND AND SUMMARY

It is known in the art to make the rear ground wheels of a combine steerable to facilitate maneuvering of the machine. However, the extent to which the wheels can be turned is limited, due in part to the relatively close proximity of the combine's chassis. Thus, the turning radius of the combine is compromised, as the front portion of the inside wheel during a turn must not be allowed to turn so far that it would strike the chassis. While it is generally desirable to use the largest and widest tires possible on the combine in order to properly support its load while minimizing soil compaction, increasing the tire size further limits the extent to which the wheels can be turned without striking the chassis. This problem has been exascerbated in recent years as combines have become progressively larger and heavier.

The present invention provides the ability to turn the rear wheels more sharply than in the past by providing a rear axle that can be extended on-the-go as need be to increase the clearance between one or both of the wheels and the chassis. Preferably, at least the inside wheel in a turn can be extended. Such extension can be achieved manually by the operator as he approaches a turn, or automatically in response to a predetermined input, such as the commencement of a turn, for example. One embodiment provides the desired extendibility for ground wheels that are powered, while another provides the same extendibility for non-powered ground wheels. In the case of powered ground wheels, an arrangement is provided whereby both ground wheels may be powered by a single motor.

### BRIEF DESCRIPTION OF THE DRAWINGS

FIG. 1 is a schematic side elevational view of a combine harvester that may incorporate an extendable rear axle assembly in accordance with the principles of the present invention;

FIG. 2 is a left, rear schematic view of the chassis and certain of the ground wheels of the combine harvester;

FIG. 3 is a rear elevational view of the chassis and its relationship with the rear ground wheels;

FIG. 4 is an isometric view of the axle assembly taken from one side thereof;

FIG. 5 is an isometric view of the axle assembly taken from the opposite side thereof;

FIG. 6 is an isometric view of the axle assembly with portions of the axle removed to reveal the extendable drive apparatus and other details of construction;

FIG. 7 is an enlarged, fragmentary isometric view of the extendable drive apparatus;

FIG. 8 is an enlarged, fragmentary plan view of the extendable drive apparatus;

FIG. 9 is another enlarged, fragmentary isometric view of the extendable drive apparatus; and

FIG. 10 is a further enlarged fragmentary isometric view of one end of the extendable drive apparatus.

### DETAILED DESCRIPTION

The present invention is susceptible of embodiment in many different forms. While the drawings illustrate, and the specification describes, certain preferred embodiments of the invention, it is to be understood that such disclosure is by way of example only. There is no intent to limit the principles of the present invention to the particular disclosed embodiments. Directional references such as “left” and “right” in this specification are given as if the machine were being viewed from the rear looking forwardly.

FIG. 1 illustrates a combine harvester 10 that may incorporate a rear axle assembly in accordance with the principles of the present invention. In general terms, combine 10 includes a chassis 12 having a front end 14 and a rear end 16. A pair of front driven wheels 18 (see also FIG. 2) support the front end 14 of chassis 12, while a pair of rear wheels 20, which may or may not be driven, support the rear end 16 of chassis 12.

Chassis 12 supports at its front end 14 a harvesting header 22 that may take a variety of different forms within the context of the present invention. A feeder house 24 conveys harvested crop materials from header 22 rearwardly and upwardly to processing mechanism broadly denoted by the numeral 26 and carried by chassis 12. Grain that has been threshed and cleaned by mechanism 26 is stored in an onboard grain tank 28 and then periodically off-loaded via an unloading spout 30, while trash and other residue from the processing operation is discharged from the rear of combine 10 and scattered by a rotor 32.

Referring particularly to the other drawing figures, rear wheels 20 comprise part of a rear axle assembly supporting the rear end 16 of chassis 12 and broadly denoted by the numeral 34. Axle assembly 34 is attached to chassis 12 by a sturdy center-pivot mounting structure 36 joined to opposite side frames 42 and 44 of chassis 12. A fore-and-aft pivot 46 associated with mounting structure 36 enables axle assembly 34 to rock up and down at its opposite ends as need be to accommodate changes in terrain and side hill operations.

In one embodiment rear wheels 20 are driven, while in another embodiment they are not. In either event, wheels 20 are mounted on opposite ends of an extendable transverse axle that comprises part of axle assembly 34. Axle 36 includes anon-extending center section 50 secured to chassis 12 by the mounting structure 36 and a pair of extendable opposite end sections 52 and 54 that are extendably attached to center section 50. In a preferred embodiment, both center section 50 and end sections 52, 54 are tubular, and end sections are telescopically received within center section 50. Preferably, sections 50, 52 and 54 comprise rectangular, tubular beams. In a powered embodiment of axle assembly 34, as hereinafter explained in more detail, center section 50 may also include a central housing 56 that contains and protects portions of a drive mechanism for rear wheels 20.

Axle assembly 34 further comprises a pair of remotely operable power devices 58, preferably in the form of double-acting hydraulic cylinders, that are coupled between center section 50 and respective ones of the end sections 52, 54 for extending and retracting the same relative to center section 50. Operation of extension cylinders 58 is controlled by means not illustrated and may include, for example, a manual control wherein the driver may cause cylinders 58 to extend or retract at his initiation, or an automatic control wherein the cylinders 58 are caused to extend or retract in response to some predetermined input, such as the commencement or completion of a turn by the harvester. The control may also be such that only one of the cylinders 58 would be extended, to extend only one of the wheels 20, such as the inside wheel on a turn, while the other wheel 20 remains unextended.

Wheels 20 are mounted on the outer ends of end sections 52, 54 by a pair of respective wheel mounts 60. In a powered wheel embodiment, mounts 60 may include an outboard planetary final drive of conventional construction for wheels 60, while in a non-powered embodiment mounts 60 do not include such a final drive. In either embodiment, mounts 60, and thus wheels 20, are attached to end sections 52, 54 for swiveling movement about respective, generally upright (although slightly inclined) axes so that wheels 20 may be steered. A yoke 62 on each mount 60 projects inwardly therefrom and is coupled with the outer end of corresponding end section 52 or 54 by suitable upright pivot structure 64 that defines the wheel's axis of swiveling movement.

Axle assembly 34 additionally includes steering mechanism, broadly denoted by the numeral 66, that is operably coupled with rear wheels 20 for effecting steering thereof. In a preferred embodiment, such steering mechanism 66 includes a pair of double-acting hydraulic cylinders 68, one for each wheel 20, operably connected between the end sections 52, 54 and wheels 20. A mounting bar 70 for each steering cylinder 68 is fixed at one end to the outer end of the corresponding outer section 52 or 54 and extends diagonally inwardly therefrom to terminate in a free end 72. Each of the steering cylinders 68 is pivotally connected at an inboard end to the free end 72 of the corresponding bar 70 and is pivotally connected at an outboard end to a lug 74 on the corresponding yoke 62. Thus, during extension and retraction of end sections 52, 54, steering cylinders travel with the moving end sections such that no steering of wheels 20 is caused by the mere act of extending or retracting axle 48. Accordingly, the toe-in angle of wheels 20 need not be adjusted merely because of extension or retraction of axle 48.

Rear axle assembly 34 may also include drive mechanism, broadly denoted by the numeral 76, for supplying driving power to wheels 20. Such drive mechanism 76 may preferably include a single motor 78, such as a rotary hydraulic motor or an electric motor, supported on center axle section 50. An output shaft 80 of motor 78 projects into housing 56 and carries a gear 82 that drivingly meshes with a larger gear 84 comprising part of an extendable driveshaft apparatus 86 within axle 48, such extendable driveshaft apparatus 86 also comprising a part of drive mechanism 76. Large gear 84 is part of a gear reduction and differential assembly 88 of conventional construction having a pair of oppositely projecting output shafts 90 and 92. Gear reduction and differential assembly 88, including its output shafts 90, 92, comprises a fixed, non-extending, center portion of the driveshaft apparatus 86 disposed within the center section 50 of axle 48.

Extendable driveshaft apparatus 86 further includes a pair of telescoping driveshafts 94 and 96 coupled with output shafts 90, 92 respectively and extending into axle end sections 52, 54 respectively. At their inboard ends, the telescoping driveshafts 94, 96 are coupled with their respective output shafts 90, 92 via conventional universal joints. Likewise, at their outboard ends, telescoping driveshafts 94, 96 are coupled with stub shafts 98 from the final planetary drives within mounts 60 via conventional universal joints.

In use, whether wheels 20 are driven or non-driven, either or both of the wheels may be extended while harvester 10 is traveling along its path of travel so as to increase the clearance between chassis 12 and either or both of the wheels. This permits wheels 20 to be turned more sharply than in the past so as to markedly improve the turning radius of the machine, such as during turn-around at the end of the field. Yet, at times when no turning is needed, wheels 20 can be maintained at their non-extended, minimum width positions so as to comply with governmental regulations during roading and shipping. In the case of powered rear wheels, the use of a single motor to drive both wheels, instead of two motors for the wheels, can have a positive effect on weight and cost of the machine, as well as providing other significant benefits.

The inventor(s) hereby state(s) his/their intent to rely on the Doctrine of Equivalents to determine and assess the reasonably fair scope of his/their invention as pertains to any apparatus not materially departing from but outside the literal scope of the invention as set forth in the following claims.

1. A combine harvester comprising:
a chassis having a front end and a rear end;
a harvesting header attached to said front end of the chassis;
processing mechanism mounted on the chassis for processing crop materials harvested by said header;
a pair of front wheels supporting said front end of the chassis behind the header; and
a rear axle assembly supporting said rear end of the chassis and including:
a transverse axle attached to said chassis;
a pair of rear wheels mounted on opposite ends of said axle in such a manner that the rear wheels can rotate about generally horizontal axes for over-the-ground travel and turn about generally upright axes for steering of the rear wheels; and
steering mechanism operably coupled with said rear wheels for effecting said steering,
said axle being extendable during over-the-ground travel of the harvester to increase the extent to which at least one of the rear wheels can be turned by said steering mechanism relative to said chassis.

2. A combine harvester as claimed in claim 1,
said axle including a non-extending center section secured to said chassis and a pair of opposite end sections extendably attached to said center section.

3. A combine harvester as claimed in claim 2,
said end sections being telescopically supported by said center section.

4. A combine harvester as claimed in claim 2,
said rear axle assembly further including a pair of power devices operably coupled between said center section and respective ones of said end sections for extending and retracting the end sections.

5. A combine harvester as claimed in claim 2,
said rear wheels being mounted on respective ones of said end sections,
said steering mechanism including a power device for each of said rear wheels that is operably coupled between the rear wheel and the corresponding end section.

6. A combine harvester as claimed in claim 1,
said rear axle assembly further including drive mechanism for supplying driving power to said rear wheels.

7. A combine harvester as claimed in claim 6,
said drive mechanism including extendable driveshaft apparatus within said axle.

8. A combine harvester as claimed in claim 7,
said axle including a center section fixed to said chassis and a pair of opposite end sections extendably attached to said center section,
said extendable driveshaft apparatus including a non-extending center portion within said center section and an extendable driveshaft within each of said end sections.

9. A combine harvester as claimed in claim 8,
said drive mechanism further including a motor operably coupled with said driveshaft apparatus.

10. A combine harvester as claimed in claim 9,
said motor comprising a rotary hydraulic motor.

11. A combine harvester as claimed in claim 9,
said motor comprising an electric motor.

12. A combine harvester as claimed in claim 9,
said drive mechanism further including a differential assembly operably coupled between said motor and said driveshaft apparatus.

13. A combine harvester as claimed in claim 12,
said center portion of said driveshaft apparatus including a first output shaft from said differential assembly and operably coupled with one of said extendable driveshafts,
said center portion of said driveshaft further including a second output shaft from said differential assembly and operably coupled with the other of said extendable driveshafts.

14. A combine harvester as claimed in claim 13,
said rear wheels being mounted on respective ones of said end sections,
said steering mechanism including a power device for each of said rear wheels that is operably coupled between the rear wheel and the corresponding end section.
